(19) United States
(12) Patent Application Publication
(10) Pub. No.: US 2024/0237790 A1
(43) Pub. Date: Jul. 18, 2024

(54) APPARATUS FOR SECURING A WALKING ASSIST DEVICE

(71) Applicant: Univate, LLC, Pickens, SC (US)

(72) Inventor: Richard M. Davidian, Pickens, SC (US)

(21) Appl. No.: 18/414,672

(22) Filed: Jan. 17, 2024

Related U.S. Application Data
(60) Provisional application No. 63/480,123, filed on Jan. 17, 2023.

(51) Int. Cl. A45B 1/04; F16M 13/02

(52) U.S. Cl. CPC A45B 1/04; F16M 13/022

(57) ABSTRACT

An apparatus adapted to secure a walking assist device is disclosed the apparatus includes a base; a hook extending outwardly from a rear surface of the base and adapted to secure the apparatus to a support; a first gripping arm extending outwardly from a first side of the base and protruding forward of a front surface of the base, the first gripping arm including a first groove formed therein; and a second gripping arm extending outwardly from a second side of the base and protruding forward of the front surface of the base, the second gripping arm including a second groove formed therein, wherein the first and second gripping arms form a holding space therebetween to secure a walking assist device therein, thereby securing the walking assist device to the support.

### BACKGROUND OF THE INVENTION

The present invention relates to an apparatus for holding accessories and, more particularly, to an apparatus for securing a user's walking assist device, such as canes.

Walking assist devices are regularly used by individuals who need additional support when walking. These individuals may be older and simply need something to help steady them, injured, or have a handicap that requires the support of the assist device. While walking assist devices provide support to a user, they are cumbersome and can often get in the way when performing a task, such as grocery shopping.

Currently, there exists no convenient way to store a cane or other walking assist device safely on a common grocery cart. Many users of such items need to resort to putting the device into the cart, in which case the device protrudes at an angle, or falls through the bottom of the cart basket vertically. Also, with motorized riding carts, the user has no choice but to prop the device in their lap sideways, which is an injury risk to other pedestrians as well as themselves. Laying the device across the top of said carts is also a risk for the operator and pedestrians.

Accordingly, there is a need for a safe, effective solution to store a cane or similar walking assisting device securely to a common grocery cart or motorized carts of the same purpose.

### BRIEF SUMMARY OF THE INVENTION

These and other shortcomings of the prior art are addressed by the present invention, which provides an apparatus adapted to enable users of a walking cane or other device to effectively and securely store the cane temporarily onto a variety of grocery carts or other wire-mesh carts such as the wire basket area used in motorized assisted grocery carts.

According to one aspect of the invention, an apparatus adapted to secure a walking assist device therein includes a base; a hook extending outwardly from a rear surface of the base and adapted to secure the apparatus to a support; a first gripping arm extending outwardly from a first side of the base and protruding forward of a front surface of the base, the first gripping arm including a first groove formed therein; and a second gripping arm extending outwardly from a second side of the base and protruding forward of the front surface of the base, the second gripping arm including a second groove formed therein, wherein the first and second gripping arms form a holding space therebetween to secure a walking assist device therein, thereby securing the walking assist device to the support.

According to another aspect of the invention, an apparatus adapted to secure a walking assist device therein includes a base; a hook extending outwardly from a rear surface of the base and adapted to secure the apparatus to a support; a first gripping arm extending outwardly from a first side of the base and protruding forward of a front surface of the base; a second gripping arm extending outwardly from a second side of the base and protruding forward of the front surface of the base, wherein the first and second gripping arms form a holding space therebetween to secure a walking assist device therein, thereby securing the walking assist device to the support; and a peg extending outwardly from at least one of the first and second gripping arms.

### BRIEF DESCRIPTION OF THE DRAWINGS

The subject matter that is regarded as the invention may be best understood by reference to the following description taken in conjunction with the accompanying drawing figures in which:

FIG. 1 is a perspective view of an apparatus in accordance with an embodiment of the invention;

FIG. 2 is a side elevation of the apparatus of FIG. 1;

FIG. 3 is a top view of the apparatus of FIG. 1;

FIG. 4 shows the apparatus of FIG. 1 secured to a mesh support;

FIG. 5 shows a perspective view of an apparatus in accordance with an embodiment of the invention;

FIG. 6 shows a top view of the apparatus of FIG. 5;

FIG. 7 shows a bottom view of the apparatus of FIG. 5;

FIG. 8 shows a perspective view of an apparatus in accordance with an embodiment of the invention;

FIG. 9 shows a rear elevation of the apparatus of FIG. 8;

FIG. 10 shows a front elevation of the apparatus of FIG. 8;

FIG. 11 shows a top view of the apparatus of FIG. 8;

FIG. 12 shows a bottom view of the apparatus of FIG. 8;

FIG. 13 is a perspective view of an apparatus in accordance with an embodiment of the invention;

FIG. 14 is a rear elevation of the apparatus of FIG. 13;

FIG. 15 is a front elevation of the apparatus of FIG. 13;

FIG. 16 is a right side view of the apparatus of FIG. 13;

FIG. 17 is a left side view of the apparatus of FIG. 13;

FIG. 18 is a top view of the apparatus of FIG. 13;

FIG. 19 is a bottom view of the apparatus of FIG. 13;

FIG. 20 is a perspective view of an apparatus in accordance with an embodiment of the invention;

FIG. 21 is a front elevation of the apparatus of FIG. 20; and

FIG. 22 is a right side view of the apparatus of FIG. 20.

### DETAILED DESCRIPTION OF THE INVENTION

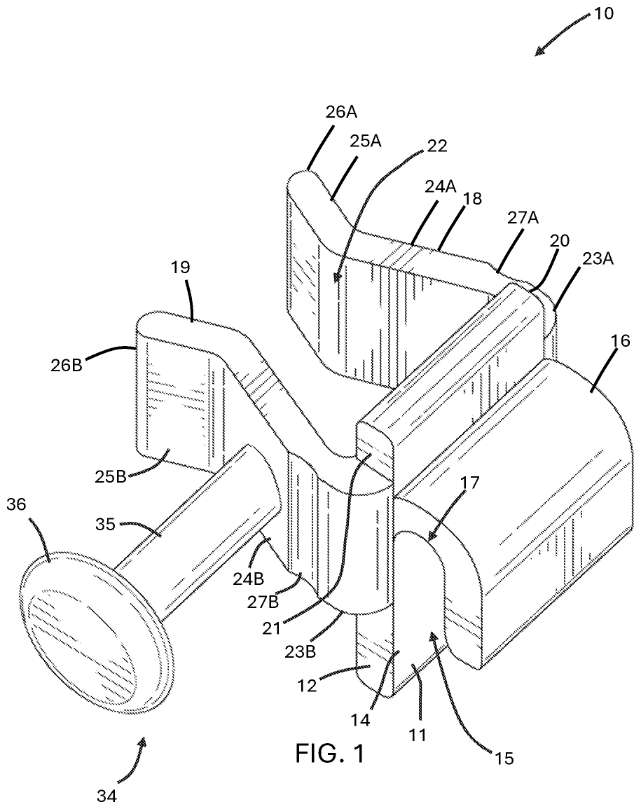

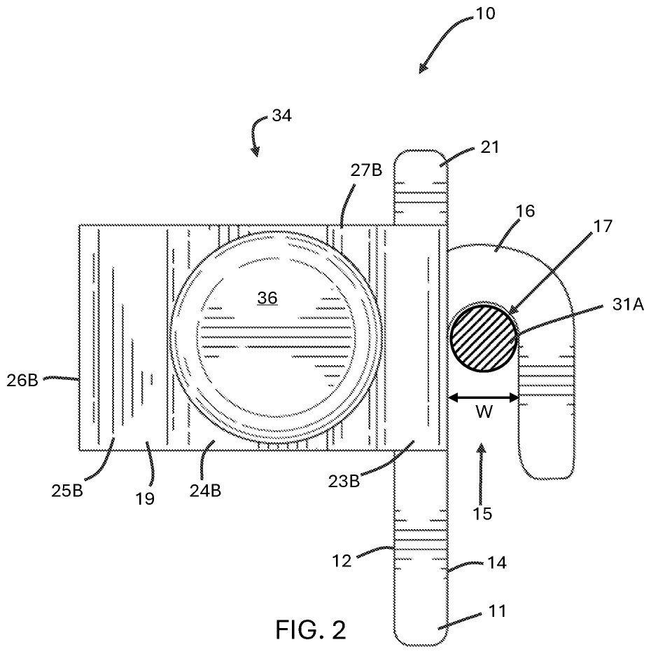

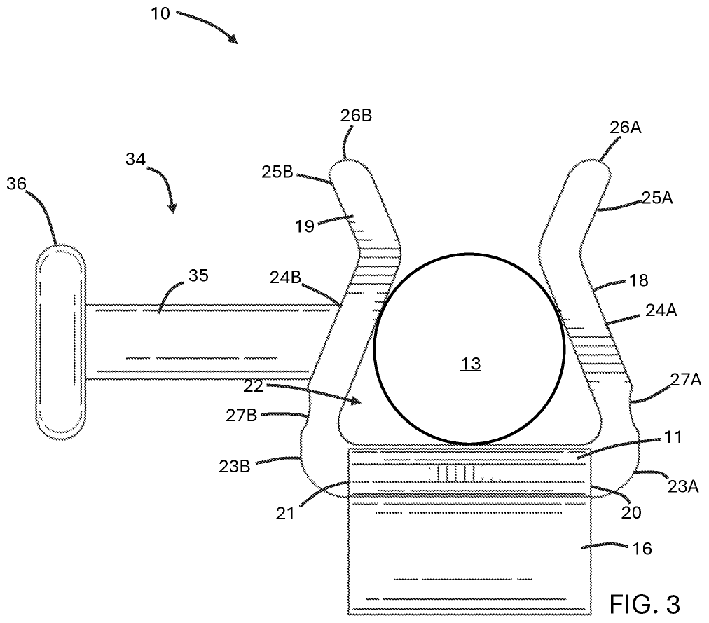

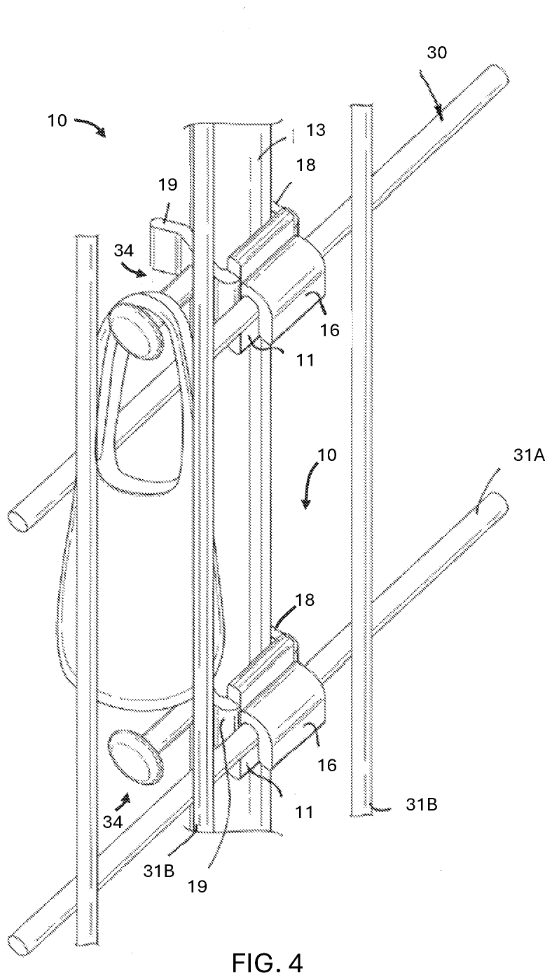

Referring to the drawings, an exemplary apparatus for securing a walking assist device according to the present invention is illustrated in FIGS. 1-4 and shown generally at reference numeral 10. The apparatus 10 includes a base 11 having a front surface 12 adapted to rest against a walking assist device 13 and a rear surface 14 adapted to rest against a support such as a mesh support 30 of a grocery cart (See FIG. 4). It should be appreciated that the apparatus 10 may be made of any suitable material for supporting and holding a walking assist device.

Hook 16 extends outwardly from the rear surface 14 of the base 11 to allow the apparatus 10 to be secured to a support. As shown, a slot or gap 15 is formed between the rear surface 14 and hook 16 to allow the hook 16 to slide over a support member 31A (FIG. 4) of support 30 and secure the apparatus 10 thereto. Gap 15 has a width “W” sufficient to accommodate support member 31A therein. For example, the gap may be from about 3.175 mm (0.125 inches) to about 9.525 mm (0.375 inches). As illustrated, a top 17 of the gap 15 is rounded or concave shaped. It should be appreciated that the top 17 may also be rectangular shaped.

First and second parallel gripping arms 18 and 19 extend outwardly from first and second opposing sides 20 and 21 of the base 11, respectively, and forward of the front surface 12 to create a holding space 22 therebetween. As illustrated, arm 18 extends outwardly and forward from side 20 and arm 19 extends outwardly and forward from side 21. As shown, at a least a portion of the base 11 extends both above and below the first and second gripping arms 18 and 19.

As illustrated, arm 18 includes a first section 23A which extends from side 20, a second section 24A extending outwardly from the first section 23A, and a third section 25A extending outwardly from the second section 24A. Arm 19 includes the same sections 23B-25B.

The first 23A, 23B and second 24A, 24B sections cooperate to form the holding space 22. As shown, the holding space 22 has a trapezoidal shape with the widest portion of the space 22 occurring at the front surface 12 and the smallest portion occurring between ends of the second sections 24A, 24B; however, any other suitable shape may be formed. The third sections 25A, 25B are angled outwardly from the second sections 24A, 24B to create a space therebetween that is at its widest point between the distal ends 26A and 26B of the third sections 25A and 25B to enable a walking assist device 13 to be pushed between the arms 18 and 19 and into the holding space 22.

The arms 18 and 19 are made of a flexible yet resilient material to permit the arms 18 and 19 to expand when the walking assist device 13 is being positioned between the arms 18 and 19 and then retract to a holding position once the device 13 has been positioned in the holding space 22, thereby securing the device 13 therein. The apparatus 10 allows devices 13 of varying sizes to be secured in the holding space 22.

Grooves 27A and 27B are formed on arms 18 and 19 at the intersection between the first and second sections. Groove 27A is formed on arm 18 at the intersection between first section 23A and second section 24A and groove 27B is formed on arm 19 at the intersection between first section 23B and second section 24B. The grooves 27A and 27B are concave shaped and provide an engagement surface for a support member 31B running perpendicular to support member 31A. For example, the apparatus 10 may be inserted between two support members 31B for engagement with both grooves 27A and 27B to hold the apparatus 10 therebetween.

As illustrated, a peg 34 extends outwardly from the second section 24B of the arm 19. It should be appreciated that the peg 34 may also extend outwardly from second section 24A of arm 18 or from both sections 24A and 24B. Peg 34 includes an arm 35 connected to the second section 24B and a knob 36 connected to a distal end of the arm 35. The peg 34 allows a user to hang a bag, purse, or other item from the apparatus 10 while in use (FIG. 4).

Referring now to FIG. 4, in use, the apparatus 10 is secured to the mesh support 30 using hook 16. As shown, the hook 16 is secured over support member 31A of the mesh support 30 such that the rear surface 14 resides adjacent to the mesh support 30. If needed or to provide a more stable connection, the apparatus 10 is positioned such that support member 31B resides against the engagement surface of the groove 27B. The apparatus 10 may also be inserted between two support members 31B having a narrow spacing such that the apparatus snaps into place between the two support members 31B and is secured therebetween by grooves 27A and 27B. As illustrated, two apparatuses 10 are secured to the mesh support 30. It should be appreciated that one or more apparatuses 10 may be used and adjusted to fit any mesh support.

Once the apparatus 10 is secured to the mesh support 30, device 13 is pushed into the holding space 22 of the apparatus 10 to securely hold the device. It should be appreciated that the apparatus 10 may also be secured to the device 13 prior to being secured to the mesh support 30 and then secured to the mesh support 30, as the device 13 does not interfere with the apparatus 10 being secured to the mesh support 30. In the latter instance, the apparatus 10 may be stored on the device 13 to prevent the apparatus 10 from being lost or to eliminate storing multiple apparatuses 10 separately.

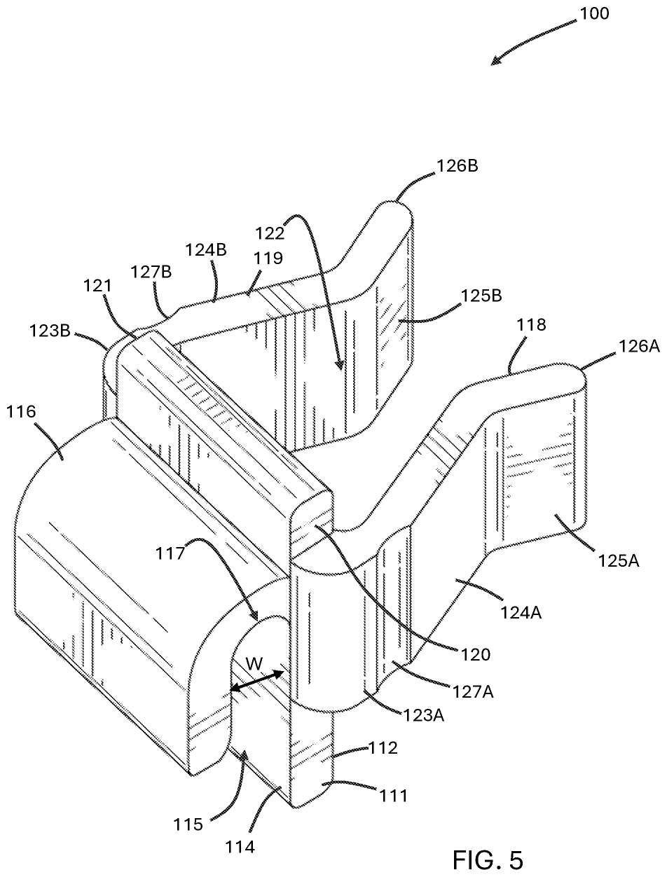

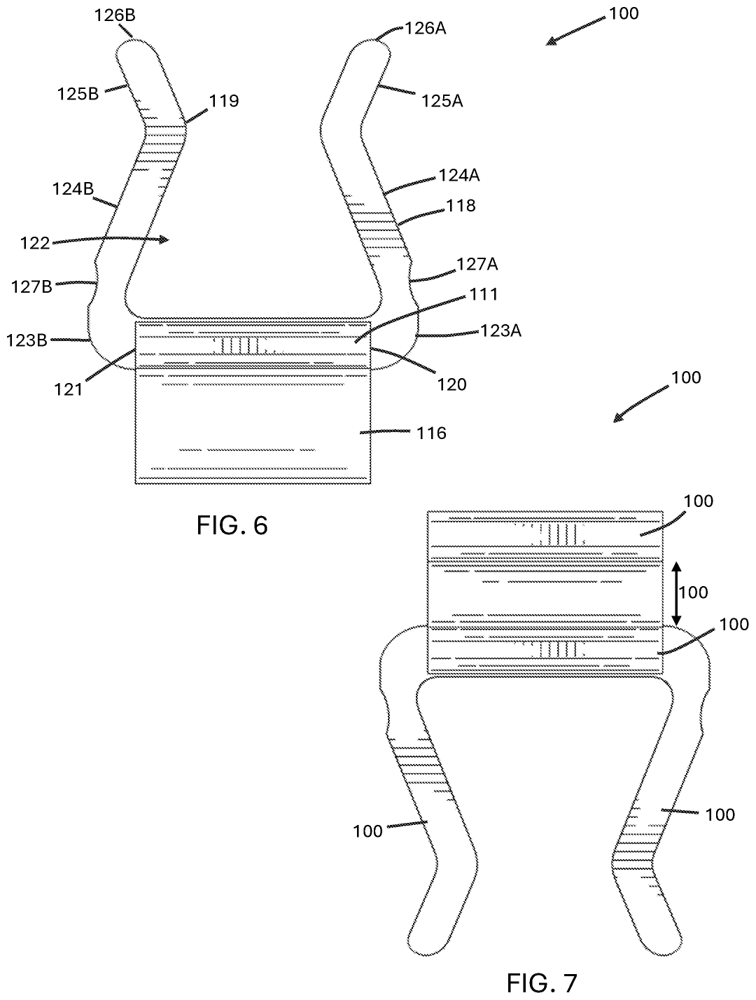

Referring now to FIGS. 5-7, an exemplary apparatus for securing a walking assist device according to the present invention is illustrated and shown generally at reference numeral 100. Like apparatus 10, apparatus 100 includes a base 111 having a front surface 112 adapted to rest against walking assist device 13 and a rear surface 114 adapted to rest against support 30. It should be appreciated that the apparatus 100 may be made of any suitable material for supporting and holding a walking assist device.

Apparatus 100 includes a hook 116 extending outwardly from the rear surface 114 of the base 111 to allow the apparatus 100 to be secured to a support; a slot or gap 115 having a width “W” formed between the rear surface 114 and hook 116 to allow the hook 116 to slide over support member 31A and secure the apparatus 100 thereto; and first and second parallel gripping arms 118 and 119 extending outwardly from first and second opposing sides 120 and 121 of the base 111, respectively, and forward of the front surface 112 to create a holding space 122 therebetween.

The width “W” of the gap 115 may be from about 3.175 mm (0.125 inches) to about 9.525 mm (0.375 inches) and includes a top 117 having a rounded or concave shape. It should be appreciated that the top 117 may also be rectangular shaped.

As illustrated, arm 118 includes a first section 123A which extends from side 120, a second section 124A extending outwardly from the first section 123A, and a third section 125A extending outwardly from the second section 124A. Arm 119 includes the same sections 123B-125B.

The first 123A, 123B and second 124A, 124B sections cooperate to form the holding space 122. As shown, the holding space 122 has a trapezoidal shape with the widest portion of the space 122 occurring at the front surface 112 and the smallest portion occurring between ends of the second sections 124A, 124B; however, any other suitable shape may be formed. The third sections 125A, 125B are angled outwardly from the second sections 124A, 124B to create a space therebetween that is at its widest point between the distal ends 126A and 126B of the third sections 125A and 125B to enable a walking assist device 13 to be pushed between the arms 118 and 119 and into the holding space 122.

The arms 118 and 119 are made of a flexible yet resilient material to permit the arms 118 and 119 to expand when the walking assist device 13 is being positioned between the arms 118 and 119 and then retract to a holding position once the device 13 has been positioned in the holding space 122, thereby securing the device 13 therein. The apparatus 100 allows devices 13 of varying sizes to be secured in the holding space 122.

Grooves 127A and 127B are formed on arms 118 and 119 at the intersection between the first and second sections. Groove 127A is formed on arm 118 at the intersection between first section 123A and second section 124A and groove 127B is formed on arm 119 at the intersection between first section 123B and second section 124B. The grooves 127A and 127B are concave shaped and provide an engagement surface for support member 31B running perpendicular to support member 31A. For example, the apparatus 100 may be inserted between two support members 31B for engagement with both grooves 127A and 127B to hold the apparatus 100 therebetween.

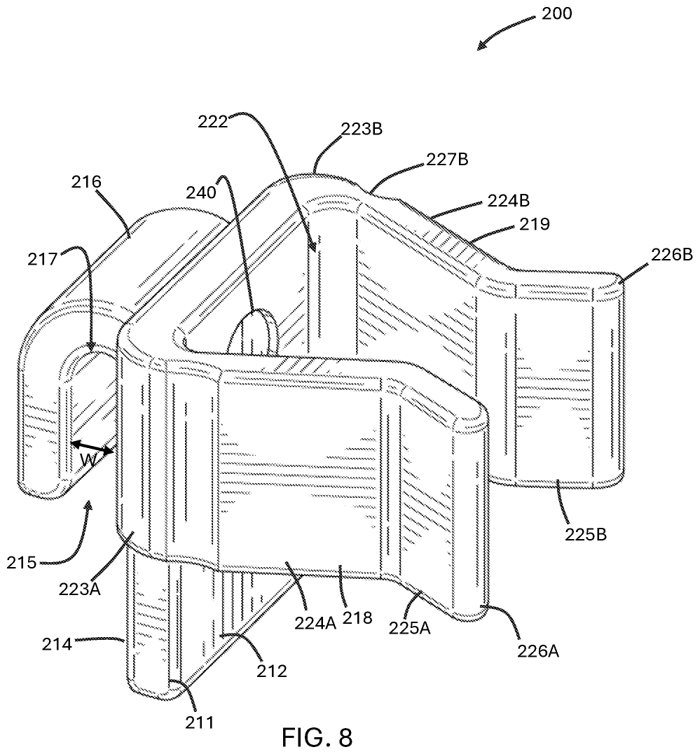

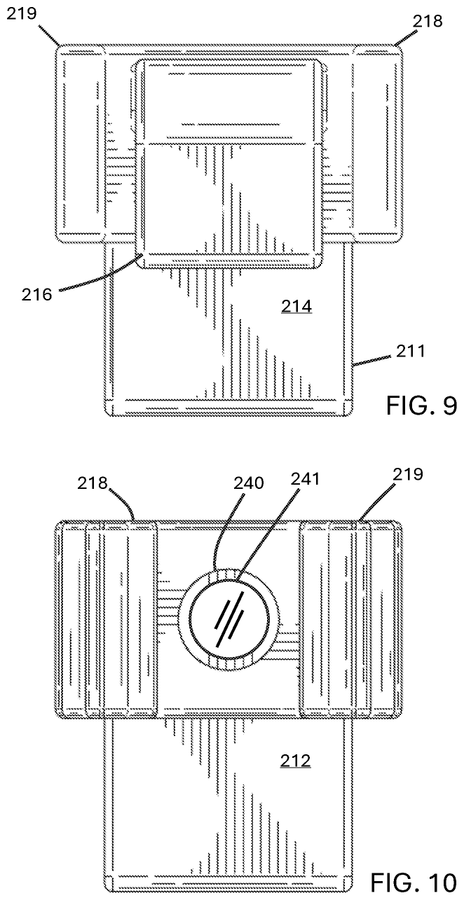

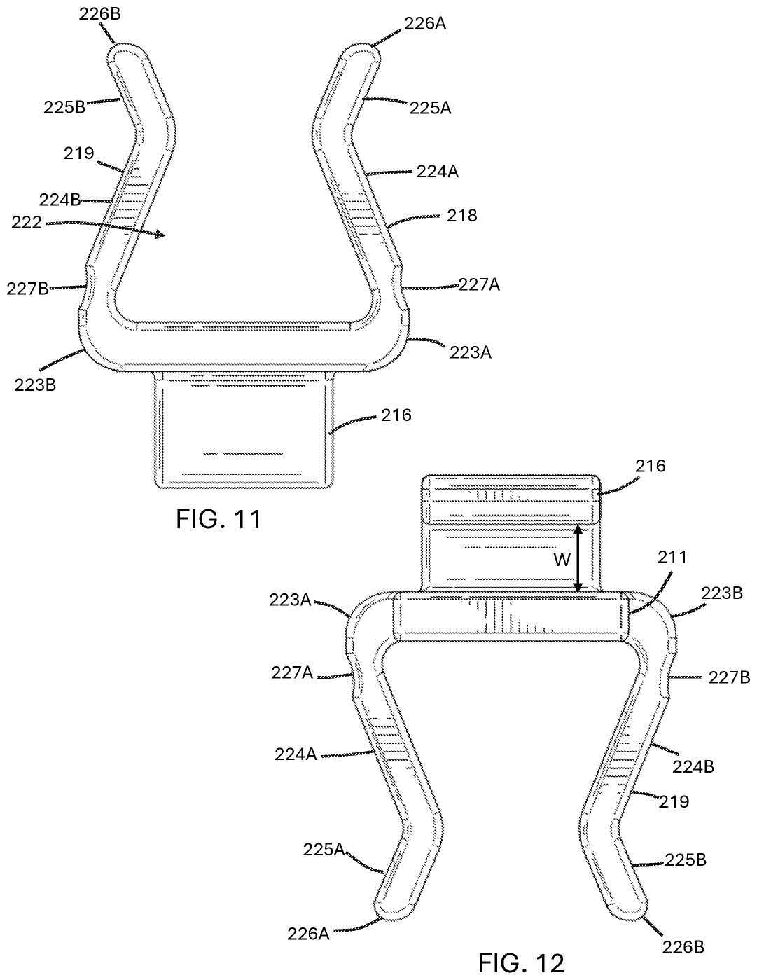

An exemplary apparatus for securing a walking assist device according to the present invention is illustrated in FIGS. 8-12 and shown generally at reference numeral 200. Like apparatus 100, apparatus 200 includes a base 211 having a front surface 212 adapted to rest against walking assist device 13 and a rear surface 214 adapted to rest against support 30. It should be appreciated that the apparatus 200 may be made of any suitable material for supporting and holding a walking assist device.

Apparatus 200 includes a hook 216 extending outwardly from the rear surface 214 of the base 211 to allow the apparatus 200 to be secured to a support; a slot or gap 215 having a width “W” formed between the rear surface 214 and hook 216 to allow the hook 216 to slide over support member 31A and secure the apparatus 200 thereto; and first and second parallel gripping arms 218 and 219 extending outwardly from first and second opposing sides 220 and 221 of the base 211, respectively, and forward of the front surface 212 to create a holding space 222 therebetween.

The width “W” of the gap 215 may be from about 3.175 mm (0.125 inches) to about 9.525 mm (0.375 inches) and includes a top 217 having a rounded or concave shape. It should be appreciated that the top 217 may also be rectangular shaped.

As illustrated, arm 218 includes a first section 223A which extends from side 220, a second section 224A extending outwardly from the first section 223A, and a third section 225A extending outwardly from the second section 224A. Arm 219 includes the same sections 223B-225B.

The first 223A, 223B and second 224A, 224B sections cooperate to form the holding space 222. As shown, the holding space 222 has a trapezoidal shape with the widest portion of the space 222 occurring at the front surface 212 and the smallest portion occurring between ends of the second sections 224A, 224B; however, any other suitable shape may be formed. The third sections 225A, 225B are angled outwardly from the second sections 224A, 224B to create a space therebetween that is at its widest point between the distal ends 226A and 226B of the third sections 225A and 225B to enable a walking assist device 13 to be pushed between the arms 218 and 219 and into the holding space 222.

The arms 218 and 219 are made of a flexible yet resilient material to permit the arms 218 and 219 to expand when the walking assist device 13 is being positioned between the arms 218 and 219 and then retract to a holding position once the device 13 has been positioned in the holding space 222, thereby securing the device 13 therein. The apparatus 200 allows devices 13 of varying sizes to be secured in the holding space 222.

Grooves 227A and 227B are formed on arms 218 and 219 at the intersection between the first and second sections. Groove 227A is formed on arm 218 at the intersection between first section 223A and second section 224A and groove 227B is formed on arm 219 at the intersection between first section 223B and second section 224B. The grooves 227A and 227B are concave shaped and provide an engagement surface for support member 31B running perpendicular to support member 31A. For example, the apparatus 200 may be inserted between two support members 31B for engagement with both grooves 227A and 227B to hold the apparatus 200 therebetween.

Apparatus 200 further includes a recess 240 in front surface 212. Recess 240 is configured to receive a securing aid 241 (FIG. 10) such as of a magnet, plunger, or pad therein. For example, a magnet could be used to help hold a metal walking assist device in the space 222 or a plunger or pad could be used to push the walking device slightly outwardly from the front surface 212 towards the arms 218, 219 to provide a more snug fit in the space 222.

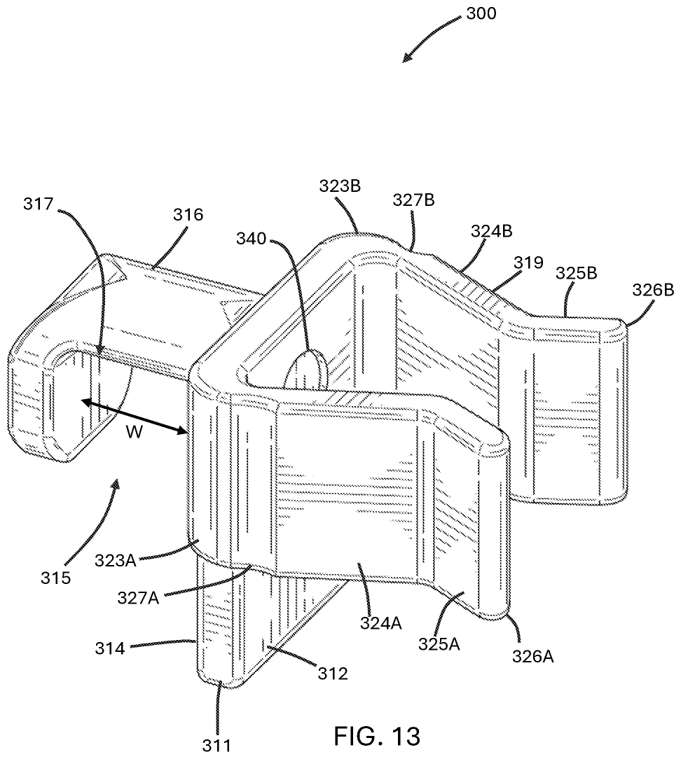

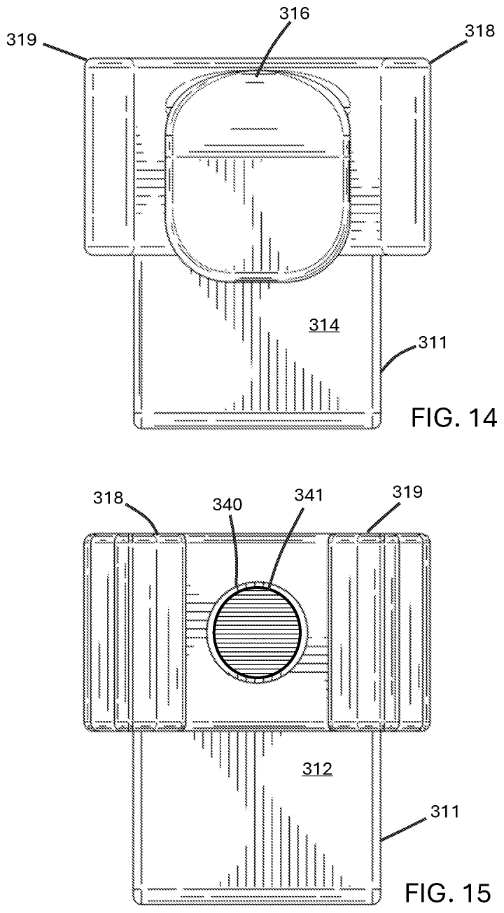

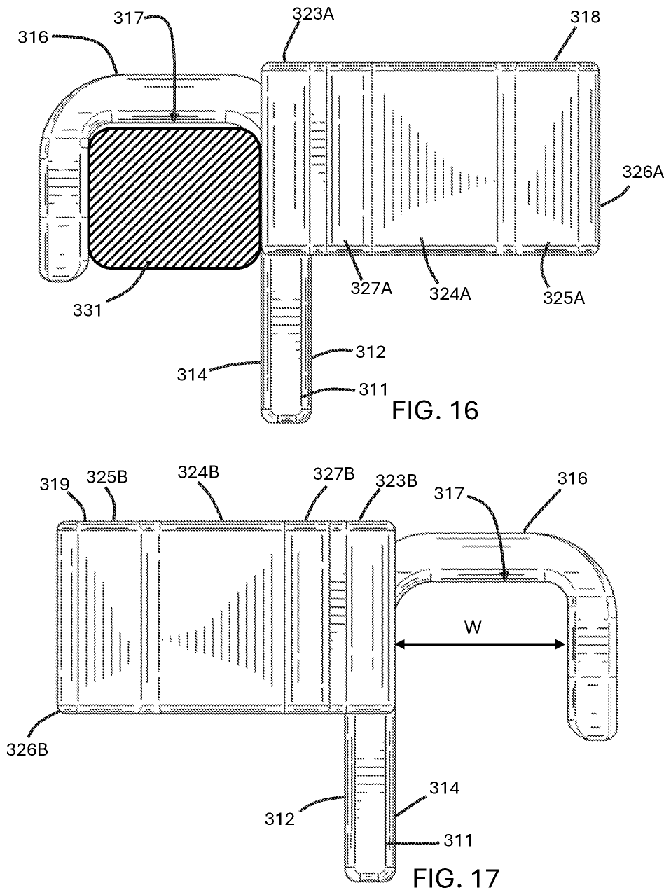

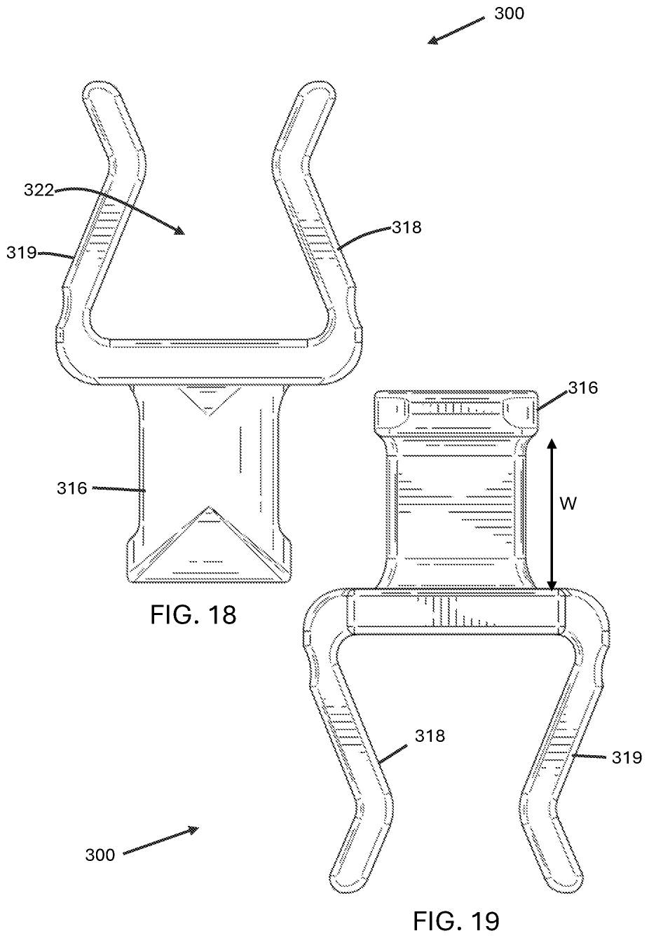

An exemplary apparatus for securing a walking assist device according to the present invention is illustrated in FIGS. 13-19 and shown generally at reference numeral 300. Like apparatus 200, apparatus 300 includes a base 311 having a front surface 312 adapted to rest against walking assist device 13 and a rear surface 314 adapted to rest against support, like support 30. It should be appreciated that the apparatus 300 may be made of any suitable material for supporting and holding a walking assist device.

Apparatus 300 includes a hook 316 extending outwardly from the rear surface 314 of the base 311 to allow the apparatus 300 to be secured to a support; a slot or gap 315 having a width “W” formed between the rear surface 314 and hook 316 to allow the hook 316 to slide over a support member 331 and secure the apparatus 300 thereto; and first and second parallel gripping arms 318 and 319 extending outwardly from first and second opposing sides 320 and 321 of the base 311, respectively, and forward of the front surface 312 to create a holding space 322 therebetween.

The width “W” of the gap 315 may be from about 6.35 mm (0.25 inches) to about 25.4 mm (1.0 inches) and includes a top 317 having a rectangular shape to accommodate larger support members 331. It should be appreciated that the top 317 may be any suitable shape to accommodate a support member 331.

As illustrated, arm 318 includes a first section 323A which extends from side 320, a second section 324A extending outwardly from the first section 323A, and a third section 325A extending outwardly from the second section 324A. Arm 319 includes the same sections 323B-325B.

The first 323A, 323B and second 324A, 324B sections cooperate to form the holding space 322. As shown, the holding space 322 has a trapezoidal shape with the widest portion of the space 322 occurring at the front surface 312 and the smallest portion occurring between ends of the second sections 324A, 324B; however, any other suitable shape may be formed. The third sections 325A, 325B are angled outwardly from the second sections 324A, 324B to create a space therebetween that is at its widest point between the distal ends 326A and 326B of the third sections 325A and 325B to enable a walking assist device 13 to be pushed between the arms 318 and 319 and into the holding space 322.

The arms 318 and 319 are made of a flexible yet resilient material to permit the arms 318 and 319 to expand when the walking assist device 13 is being positioned between the arms 318 and 319 and then retract to a holding position once the device 13 has been positioned in the holding space 322, thereby securing the device 13 therein. The apparatus 300 allows devices 13 of varying sizes to be secured in the holding space 322.

Grooves 327A and 327B are formed on arms 318 and 319 at the intersection between the first and second sections. Groove 327A is formed on arm 318 at the intersection between first section 323A and second section 324A and groove 327B is formed on arm 319 at the intersection between first section 323B and second section 324B. The grooves 327A and 327B are concave shaped and provide an engagement surface for support member 31B running perpendicular to support member 331. For example, the apparatus 300 may be inserted between two support members 331 for engagement with both grooves 327A and 327B to hold the apparatus 300 therebetween.

Apparatus 300 further includes a recess 340 in front surface 312. Recess 340 is configured to receive a securing aid 341 (FIG. 15) such as of a magnet, plunger, or pad therein. For example, a magnet could be used to help hold a metal walking assist device in the space 322 or a plunger or pad could be used to push the walking device slightly outwardly from the front surface 312 towards the arms 318, 319 to provide a more snug fit in the space 322.

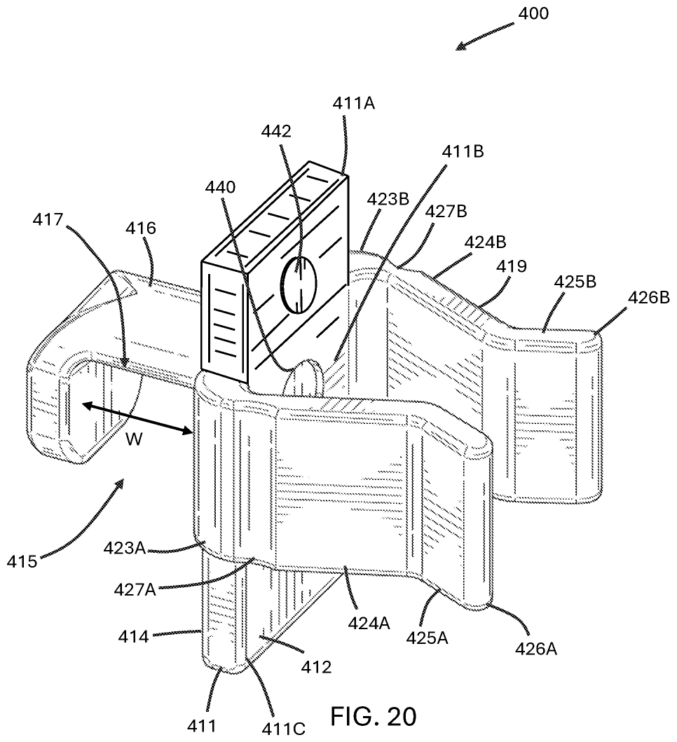

An exemplary apparatus for securing a walking assist device according to the present invention is illustrated in FIGS. 20-22 and shown generally at reference numeral 400. Like apparatus 300, apparatus 400 includes a base 411 having a front surface 412 adapted to rest against walking assist device 13 and a rear surface 414 adapted to rest against a support, like support 30. It should be appreciated that the apparatus 400 may be made of any suitable material for supporting and holding a walking assist device.

Apparatus 400 includes a hook 416 extending outwardly from the rear surface 414 of the base 411 to allow the apparatus 400 to be secured to a support; a slot or gap 415 having a width “W” formed between the rear surface 414 and hook 416 to allow the hook 416 to slide over a support member 431 and secure the apparatus 400 thereto; and first and second parallel gripping arms 418 and 419 extending outwardly from first and second opposing sides 420 and 421 of the base 411, respectively, and forward of the front surface 412 to create a holding space 422 therebetween.

The width “W” of the gap 415 may be from about 3.175 mm (0.125 inches) to about 9.525 mm (0.375 inches) as shown in apparatus 10 or, as shown, from about 6.35 mm (0.25 inches) to about 25.4 mm (1.0 inches) and includes a top 417 having a rectangular shape to accommodate larger support members 431. It should be appreciated that the top 417 may be any suitable shape to accommodate a support member 431.

As illustrated, arm 418 includes a first section 423A which extends from side 420, a second section 424A extending outwardly from the first section 423A, and a third section 425A extending outwardly from the second section 424A. Arm 419 includes the same sections 423B-425B.

The first 423A, 423B and second 424A, 424B sections cooperate to form the holding space 422. As shown, the holding space 422 has a trapezoidal shape with the widest portion of the space 422 occurring at the front surface 412 and the smallest portion occurring between ends of the second sections 424A, 424B; however, any other suitable shape may be formed. The third sections 425A, 425B are angled outwardly from the second sections 424A, 424B to create a space therebetween that is at its widest point between the distal ends 426A and 426B of the third sections 425A and 425B to enable a walking assist device 13 to be pushed between the arms 418 and 419 and into the holding space 422.

The arms 418 and 419 are made of a flexible yet resilient material to permit the arms 418 and 419 to expand when the walking assist device 13 is being positioned between the arms 418 and 419 and then retract to a holding position once the device 13 has been positioned in the holding space 422, thereby securing the device 13 therein. The apparatus 400 allows devices 13 of varying sizes to be secured in the holding space 422.

Grooves 427A and 427B are formed on arms 418 and 419 at the intersection between the first and second sections. Groove 427A is formed on arm 418 at the intersection between first section 423A and second section 424A and groove 427B is formed on arm 419 at the intersection between first section 423B and second section 424B. The grooves 427A and 427B are concave shaped and provide an engagement surface for support member 31B running perpendicular to support member 431. For example, the apparatus 400 may be inserted between two support members 31B for engagement with both grooves 427A and 427B to hold the apparatus 400 therebetween.

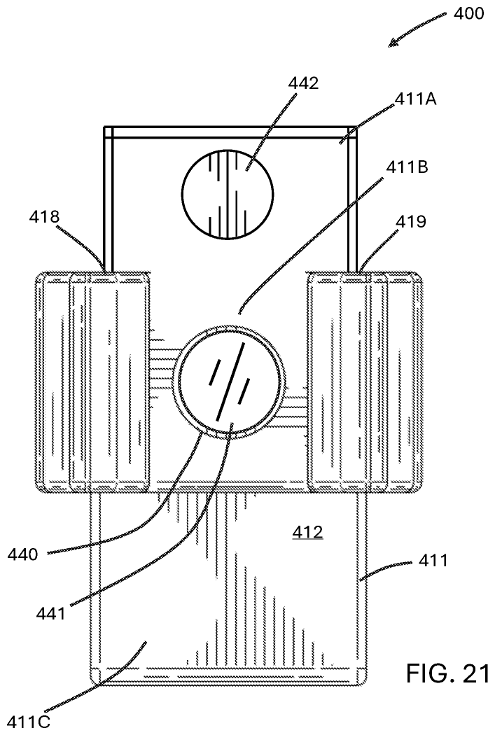

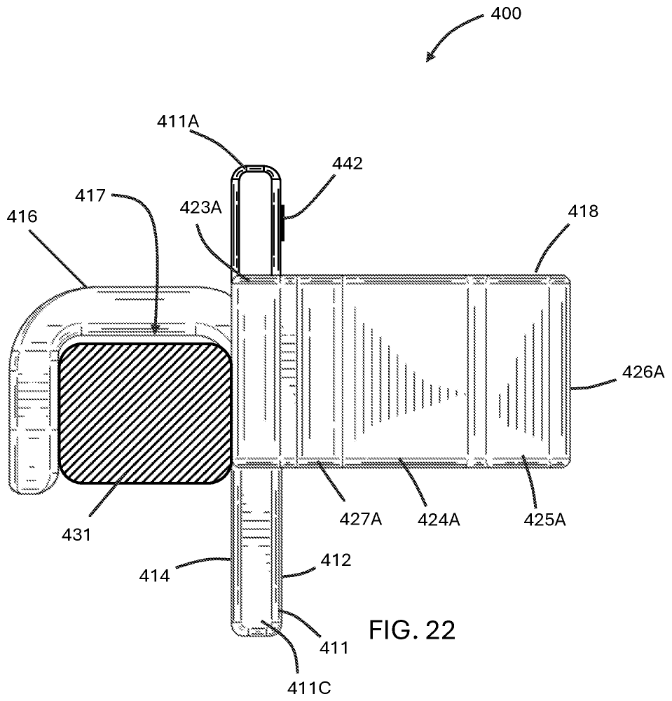

Base 411 of the apparatus 400 extends both above and below the first and second gripping arms 418 and 419. Thus, the base 411 includes an upper base portion 411A, a middle base portion 411B, and a lower base portion 411C. A recess 440 is positioned in the front surface 412 of the middle base portion 411B. Recess 440 is configured to receive a securing aid 441 (FIG. 21) such as of a magnet, plunger, or pad therein. For example, a magnet could be used to help hold a metal walking assist device in the space 422 or a plunger or pad could be used to push the walking device slightly outwardly from the front surface 412 towards the arms 418, 419 to provide a more snug fit in the space 422. Additionally, an additional securing aid 442 is positioned on the front surface 412 of the upper base portion 411A to add stability and help hold the device 13. The securing aid 442 may be disposed directly on the front surface 412 or positioned in a recess like 440.

The foregoing has described an apparatus for securing a user's walking assist device. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

I claim:

1. An apparatus adapted to secure a walking assist device therein, comprising:
a base;
a hook extending outwardly from a rear surface of the base and adapted to secure the apparatus to a support;
a first gripping arm extending outwardly from a first side of the base and protruding forward of a front surface of the base, the first gripping arm including a first groove formed therein; and
a second gripping arm extending outwardly from a second side of the base and protruding forward of the front surface of the base, the second gripping arm including a second groove formed therein, wherein the first and second gripping arms form a holding space therebetween to secure a walking assist device therein, thereby securing the walking assist device to the support.

2. The apparatus of claim 1, further including a peg extending outwardly from at least one of the first and second gripping arms.

3. The apparatus of claim 1, further including a recess formed in the front surface of the base, the recess being adapted to receive a securing aid therein.

4. The apparatus of claim 1, wherein a gap is formed between the hook and the rear surface of the base, the gap having a width of about 3.175 mm to about 9.525 mm.

5. The apparatus of claim 1, wherein a gap is formed between the hook and the rear surface of the base, the gap having a width of about 6.35 mm to about 25.4 mm.

6. The apparatus of claim 1, wherein the first arm includes a first section extending outwardly from the first side, a second section extending inwardly towards the holding space from the first section, and a third section extending outwardly from the second section.

7. The apparatus of claim 1, wherein the second arm includes a first section extending outwardly from the second side, a second section extending inwardly towards the holding space from the first section, and a third section extending outwardly from the second section.

8. The apparatus of claim 1, wherein distal ends of the first and second gripping arms cooperate to form a mouth adapted to receive the walking assist device and allow it to be pushed into the holding space.

9. The apparatus of claim 6, wherein the first groove is formed at an intersection between the first and second sections of the first arm.

10. The apparatus of claim 7, wherein the second groove is formed at an intersection between the first and second sections of the second arm.

11. The apparatus of claim 1, wherein the base includes an upper base portion extending above the first and second gripping arms and a lower base portion extending below the first and second gripping arms.

12. The apparatus of claim 11, wherein a securing aid is positioned on the front surface of the upper base portion.

13. An apparatus adapted to secure a walking assist device therein, comprising:
a base;
a hook extending outwardly from a rear surface of the base and adapted to secure the apparatus to a support;
a first gripping arm extending outwardly from a first side of the base and protruding forward of a front surface of the base;
a second gripping arm extending outwardly from a second side of the base and protruding forward of the front surface of the base, wherein the first and second gripping arms form a holding space therebetween to secure a walking assist device therein, thereby securing the walking assist device to the support; and
a peg extending outwardly from at least one of the first and second gripping arms.

14. The apparatus of claim 13, wherein the peg includes an arm and a knob positioned on a distal end of the arm.

15. The apparatus of claim 13, wherein the first arm includes a first section extending outwardly from the first side, a second section extending inwardly towards the holding space from the first section, and a third section extending outwardly from the second section, and wherein a first groove is formed at an intersection between the first and second sections of the first arm.

16. The apparatus of claim 13, wherein the second arm includes a first section extending outwardly from the second side, a second section extending inwardly towards the holding space from the first section, and a third section extending outwardly from the second section, and wherein a second groove is formed at an intersection between the first and second sections of the second arm.

17. A method of using the apparatus of claim 1, comprising:
positioning the apparatus on a first support using the hook to secure the apparatus thereto;
positioning the walking assist device between the first and second gripping arms; and pushing the walking assist device into a holding space created between the first and second gripping arms.

18. The method of claim 17, further comprising the steps of positioning a second support in the first groove and a third support in the second groove to secure the apparatus thereto.

19. An apparatus adapted to secure a walking assist device therein, comprising:
a base having an upper base portion and a lower base portion;
a hook extending outwardly from a rear surface of the base and adapted to secure the apparatus to a support;
a first gripping arm extending outwardly from a first side of the base and protruding forward of a front surface of the base, the first gripping arm including a first groove formed therein; and
a second gripping arm extending outwardly from a second side of the base and protruding forward of the front surface of the base, the second gripping arm including a second groove formed therein, wherein the first and second gripping arms form a holding space therebetween to secure a walking assist device therein, thereby securing the walking assist device to the support.

20. The apparatus of claim 19, wherein the upper base portion is positioned above the first and second gripping arms and the lower base portion is positioned below the first and second gripping arms, and wherein a securing aid is positioned on the front surface of the upper base portion.
